(19) United States
(12) Patent Application Publication
(10) Pub. No.: US 2003/0176310 A1
(43) Pub. Date: Sep. 18, 2003

(54) Chitosan/anionic surfactant complex membrane

(76) Inventors: Robert Y.M. Huang, Waterloo (CA); Rajinder Pal, Waterloo (CA); Go Young Moon, Seongnam City (KR)

Correspondence Address: Gowling Lafleur Henderson LLP, Commerce Court West, Suite 4900, Toronto, ON, M5L1J3, CA

(21) Appl. No.: 10/097,576

(22) Filed: Mar. 15, 2002

(51) Int. Cl. C11D 3/37; C11D 17/00

(52) U.S. Cl. 510/475; 510/424

(57) ABSTRACT

A composite membrane material is provided comprising an active membrane including chitosan complexed with an anionic surfactant, and porous substrate membrane including a hydrophobic polymer. The active membrane is physically adhered to the porous substrate membrane. The active membrane and the porous substrate define an interface, wherein the porous substrate membrane includes an interfacial surface disposed at the interface, and wherein the hydrophobic polymer of the porous substrate membrane is disposed at the interfacial surface. The chitosan is bonded to the anionic surfactant. The porous substrate membrane is characterized by no more than 0.3% water absorption according to ASTM-D570. The hydrophobic polymer includes any of polysulfone, polyetherimide, polyvinylidene fluoride, or polystyrene. The anionic surfactant is a non-linear, branched chain surfactant. The anionic surfactant includes any one of sodium dodecyl sulfate, sodium laurate, sodium stearate, dioctyl sodium sulfosuccinate, and amphoteric sodium N-lauroyl sarcosinate. The composite membrane is formed by a method comprising the steps of (i) providing a porous substrate membrane including a hydrophobic polymer, (ii) casting a solution comprising chitosan complexed with an anionic surfactant on a surface of the porous substrate membrane to form a first intermediate; and (iii) drying the first intermediate to form the composite membrane.

### FIELD OF THE INVENTION

The present invention relates to a novel composite membrane material and, more particularly, a novel composite membrane material comprising a surfactant modified chitosan membrane supported by a porous substrate.

### BACKGROUND OF THE INVENTION

In recent years, there has been increased interest in the use of pervaporation membrane separation techniques for the selective separation of organic liquid mixtures because of their high separation efficiency and flux rates coupled with potential savings in energy costs.

Pervaporation is the separation of liquid mixtures by partial vaporization through a non-porous permselective membrane. During its transport through the membrane, components of the liquid mixture diffusing through the membrane undergo a phase change, from liquid to vapor. This phase change occurring through the membrane makes the pervaporation process unique among membrane processes. The permeate, or product, is removed as a low-pressure vapor, and, thereafter, can be condensed and collected or released as desired.

In a typical pervaporation process, a liquid mixture feed is contacted with one side of a dense non-porous membrane. After dissolving in and diffusing through the membrane, the permeate is removed from the downstream side in the vapor phase under vacuum or swept out in a stream of inert carrier gas. Separation of individual components of the liquid mixture feed requires that physicochemical interactions with the membrane be different for the individual components, Such interactions affect the permeation rate of each of the individual components through the membrane, thereby giving rise to separation.

Membrane performance in the pervaporation context is measured by its selectivity. The selectivity of a membrane for the separation of a mixture comprised of components A and B may be described by the separation factor ∞ which is defined as follows:

$$∝ = \frac{Y / ( 1 - Y )}{X / ( 1 - X )}$$

where X and Y are the weight fractions of the more permeable component A in the feed and permeate, respectively. In addition to being selective, however, it is desirable for a membrane to have good permeability. Otherwise, despite high selectivity, acceptable separations will not be achieved where the membrane is relatively impermeable for components in the liquid feed.

Pervaporation membrane processes are finding their application niches in the chemical industries as a process for breaking azeotropic concentration after distillation or as an intermediate between distillation processes. Most of the pervaporation studies published in journals have focused on the discovery and the modification of new membrane materials for specific mixture separation. After the successful industrialization of plasma-polymerized and cross-linked PVA membranes for alcohol dehydration systems, much research attention has been paid to the polysaccharide natural polymers such as chitosan because of its reasonably good hydrophilicities and film form properties.

Chitin, poly-(1→4)-β-N-acetyl-D-glucosamine, the most abundant natural polymer next to cellulose, is widely found in skeletons of crustaceans such as shrimps, crabs and lobsters, and in cell walls of microorganisms. Seafood waste from shrimps, lobsters and crabs generally contains 10-15% chitin. Chitin and, its deacetylated derivative, chitosan are finding applications in pharmaceutical system such as surgical suture and drug delivery, enzyme immobilization, and metal ion chelation.

Chitosan membranes are typically cast on a porous support membrane to enhance structural integrity. However, owing to the hydrophilic characteristics of chitosan membranes, choice of porous support membranes has been until now limited to those with complementary hydrophilic characteristics to reduce the risk of a resultant unstable composite membrane structure.

### SUMMARY OF THE INVENTION

According to the present invention, there is provided a composite membrane material comprising an active membrane including chitosan complexed with a anionic surfactant, and a porous substrate membrane including a hydrophobic polymer.

In one aspect of the invention, the composite membrane material comprises an active membrane consisting essentially of chitosan complexed with an anionic surfactant and a porous substrate membrane including a hydrophobic polymer.

In another aspect of the present invention, the composite membrane comprises an active membrane including chitosan complexed with a non-linear branched chain anionic surfactant, and a porous substrate membrane.

In yet another aspect of the present invention, the composite membrane comprises an active membrane consisting essentially of chitosan complexed with a non-linear branched chain anionic surfactant, and a porous substrate membrane.

In a further aspect of the present invention, the composite membrane is formed by a method comprising the steps of (i) providing a porous substrate membrane including a hydrophobic polymer, (ii) casting a solution comprising chitosan complexed with an anionic surfactant on a surface of the porous substrate membrane to form a first intermediate, and (iii) drying the first intermediate to form the composite membrane.

### DESCRIPTION OF DRAWINGS

The invention will be better understood with reference to the drawings, in which:

FIG. 1 is a schematic diagram of the pervaporation apparatus used in the invention.

FIG. 2 is a tentative model of the formation of the chitosan-anionic surfactant complex in the solution. The diagram shows surfactant molecules binding to a chitosan chain according to the increase of the amount of surfactant from A (initiation of binding) to C (shrunk coil).

FIG. 3 shows the chemical structures of anionic surfactants: (A) sodium dodecyl sulfate (SDS), C₁₂H₂₅NaO₄S; (B) sodium laurate (SL), C₁₂H₂₃NaO₂; (c) sodium stearate (SS), C₁₈H₃₅NaO₂; (D) amphoteric sodium N-lauroyl sarcosinate (SLS), C₁₅H₂₈NNaO₃ and (E) dioctyl sodium sulfosuccinate (DSS), C₂₀H₃₇NaO₇S.

FIG. 4 shows a model which describes the association behavior of the polymer and surfactants in an aqueous solution;

FIG. 5 shows an SEM picture of the composite membrane, (a) and (b) are the adjacent view and overview of the membrane cross-section without the addition of surfactant, respectively, (c) and (d) are the adjacent view and overview of the membrane cross-section with the addition of DSS surfactant, respectively;

FIG. 6 depicts the apparent viscosities of polymer solution with the addition of various surfactants at ambient temperature;

FIG. 7 shows the surfactant (DSS) concentration effect on apparent viscosities of polymer solutions at ambient temperature;

FIG. 8 shows the surfactant (SDS) concentration effect on apparent viscosities of polymer solution at ambient temperature;

FIG. 9 renders a 3D view of a horizontal view of the membrane surface: (a) pure chitosan without surfactant; (b) chitosan added with 0.006% SDS surfactant;

FIG. 10 shows the pervaporation performance of chitosan composite membranes (top layers=2 μm) complexed with various surfactants for 20% MeOH/80% MTBE at 25° C.;

FIG. 11 shows the surfactant (DSS) concentration effect on pervaporation performance for 20% MeOH/80% MTBE mixture at 25° C. (chitosan top layers≈2 μm);

FIG. 12 shows the surfactant (SDS) concentration effect on pervaporation performance for 20% MeOH/80% MTBE mixture at 25° C. (chitosan top layers=2 μm);

FIG. 13 shows the feed concentration effect on the permeation flux and MeOH concentration in the permeate of pure chitosan and DSS complexed chitosan (CS-DSS) composite membrane at 25° C.;

FIG. 14 shows the temperature effect on the permeation fluxes of pure, DSS modified, and SDS modified chitosan composite membranes for 20% MeOH/80% MTBE; and

FIG. 15 shows the temperature effect on MeOH content in the permeate of pure, DSS modified, and SDS modified chitosan composite membranes for 20% MeOH/80% MTBE.

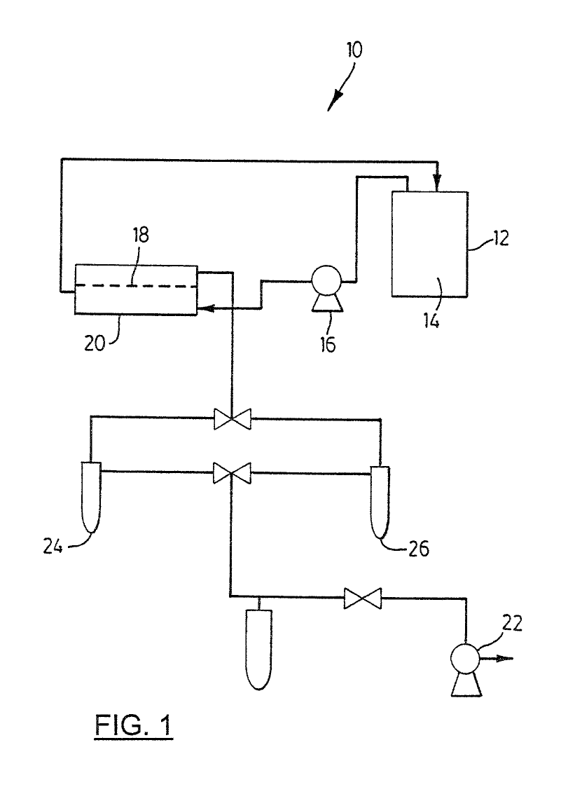

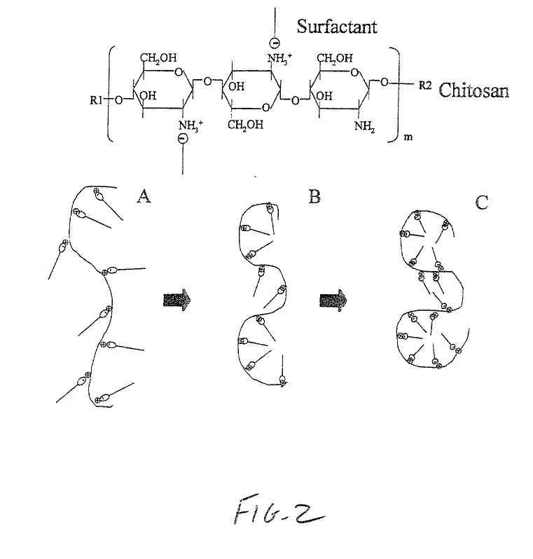

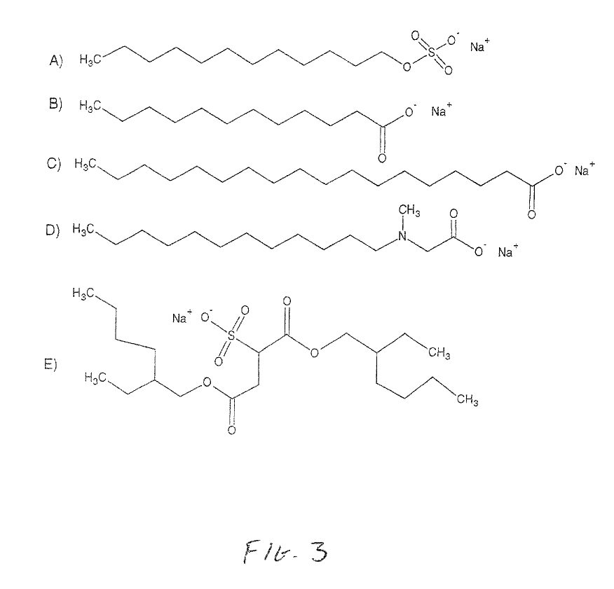

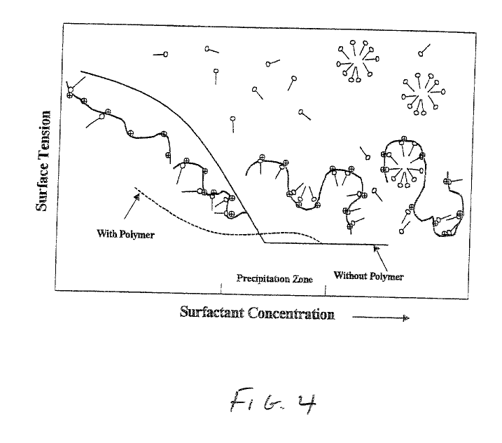

### DETAILED DESCRIPTION

The present invention relates to a composite membrane material comprising: (i) an active membrane including chitosan complexed with an anionic surfactant, and (ii) a porous substrate membrane including a hydrophobic polymer. The porous substrate membrane supports or provides mechanical reinforcement to the active membrane. The active membrane and the porous substrate interact at the interface between the active membrane and the porous substrate to form a composite asymmetric membrane. As one example, such interaction between the active membrane and the porous substrate membrane is physical adhesion.

In one embodiment, the composite membrane material comprises: (i) an active membrane including chitosan bonded to an anionic surfactant, and (ii) a porous substrate membrane including a hydrophobic polymer. The porous substrate membrane supports or provides mechanical reinforcement to the active membrane. The active membrane and the porous substrate membrane interact at the interface between the active membrane and the porous substrate membrane to form a composite asymmetric membrane. As one example, such interaction between the active membrane and the porous substrate membrane is physical adhesion.

In another embodiment, the composite membrane material comprises: (i) an active membrane including chitosan bonded to an anionic surfactant, and (ii) a porous substrate membrane including a polymer characterized by no more than 0.3% water absorption according to ASTM-D570. In this context, water absorption is expressed as a percentage increase in weight of the polymer due to absorption of water by the polymer under the test procedure specified by ASTM-D570. The porous substrate membrane supports or provides mechanical reinforcement to the active membrane. The active membrane and the porous substrate membrane interact at the interface between the active membrane and the porous substrate membrane to form a composite asymmetric membrane. As one example, such interaction between the active membrane and the porous substrate membrane is physical adhesion.

In another embodiment, the composite membrane material comprises: (i) an active membrane including chitosan bonded to an anionic surfactant, and (ii) a porous substrate, the porous substrate including a first layer comprising a porous substrate membrane and a second layer comprising a non-woven fabric, wherein the film layer and the second layer are physically adhered to one another. The porous substrate membrane of the porous substrate includes a hydrophobic polymer or a polymer characterized by no more than 0.3% water absorption according to ASTM-D570. The porous substrate supports or provides mechanical reinforcement to the active membrane. The active membrane and the porous substrate membrane of the porous substrate are physically adhered to one another to thereby form a composite asymmetric membrane.

In one embodiment, the active membrane includes a blend of chitosan and at least one other hydrophilic polymer. The at least one other hydrophillic polymer is capable of sustaining pervaporation of a polar molecule. In this respect, the hydrophillic polymer must be blendable, or miscible, with chitosan. Also, the hydrophillic polymer must include good film forming properties. Further, the hydrophillic polymer should be sufficiently robust in thin film form. An embodiment of a composite membrane of the present invention including such an additional hydrophillic polymer without these characteristics may not be adequately robust to sustain sufficient mechanical integrity during periods of substantial swelling and high temperature operation. Examples of suitable hydrophillic polymers include polyvinyl alcohol, cellulose, and sulfonated polymers.

In one embodiment, the active membrane includes at least 50 wt % chitosan, based on the total weight of the active membrane. In this respect, a sufficient amount of chitosan is present in the active membrane such that desirable properties associated with chitosan as a thin film membrane material for pervaporation separation of polar/non-polar mixtures, such as alcohol/organic mixtures, is imparted to the active membrane.

In another embodiment, a composite membrane material comprises: (i) an active membrane consisting essentially of chitosan complexed with an anionic surfactant, and (ii) a porous substrate membrane including a hydrophobic polymer. The porous substrate membrane supports or provides mechanical reinforcement to the active membrane. The active membrane and the porous substrate interact at the interface between the active membrane and the porous substrate to form a composite asymmetric membrane. As one example, such interaction between the active membrane and the porous substrate membrane is physical adhesion.

In a further embodiment, the composite membrane material comprises: (i) an active membrane consisting essentially of chitosan bonded to an anionic surfactant, and (ii) a porous substrate membrane including a hydrophobic polymer. The porous substrate membrane supports or provides mechanical reinforcement to the active membrane. The active membrane and the porous substrate membrane interact at the interface between the active membrane and the porous substrate membrane to form a composite asymmetric membrane. As one example, such interaction between the active membrane and the porous substrate membrane is physical adhesion.

In another embodiment, the composite membrane material comprises: (i) an active membrane consisting essentially of chitosan bonded to an anionic surfactant, and (ii) a porous substrate membrane including a polymer characterized by no more than 0.3% water absorption according to ASTM-D570. In this context, water absorption is expressed as a percentage increase in weight of the polymer due to absorption of water by the polymer under the test procedure specified by ASTM-D570. The porous substrate membrane supports or provides mechanical reinforcement to the active membrane. The active membrane and the porous substrate membrane interact at the interface between the active membrane and the porous substrate membrane to form a composite asymmetric membrane. As one example, such interaction between the active membrane and the porous substrate membrane is physical adhesion.

In another embodiment, the composite membrane material comprises: (i) an active membrane consisting essentially of chitosan bonded to an anionic surfactant, and (ii) a porous substrate, the porous substrate including a first layer comprising a porous substrate membrane, and a second layer comprising a non-woven fabric, wherein the first layer and the second layer are physically adhered to one another. The porous substrate membrane of the porous substrate includes a hydrophobic polymer or a polymer characterized by no more than 0.3% water absorption according to ASTM-D570. The porous substrate supports or provides mechanical reinforcement to the active membrane. The active membrane and the porous substrate membrane of the porous substrate are physically adhered to one another to thereby form a composite asymmetric membrane.

In this context, “consisting essentially of” means that the active membrane does not include additional components in amounts which noticeably derogate from the desired performance of the chitosan complexed with the anionic surfactant in the active membrane. In this respect, additional components must not be present in the active membrane in amounts which noticeably compromise the tendency of polar molecules to dissolve and permeate through the active membrane. Also, such additional components must not be present in amounts which noticeably compromise the film forming properties of the active membrane. Further, such additional components must not be present in amounts which noticeably derogate from the elasticity of the active membrane.

In one embodiment, the active layer and the porous substrate membrane define an interface, and the porous substrate membrane includes an interfacial surface disposed at the interface, wherein the polymer of the porous substrate membrane is disposed at the interfacial surface. The polymer of the porous substrate membrane interacts with the hydrophobic tail of the anionic surfactant of the active membrane to thereby contribute to physical adhesion between the porous substrate membrane and the active membrane.

In one embodiment, the active membrane is a thin film membrane and has a thickness from 0.5 μm to 100 μm. The porous substrate membrane has a thickness of 5 μm to 300 μm.

An example of a suitable non-woven fabric is polyester non-woven fabric.

The composite membrane includes an interface separating the thin film membrane from the porous substrate membrane. At the interface, the thin film membrane and the porous substrate membrane interact to form a composite membrane. It is believed that there is no permanent chemical change in either of the thin film membrane or the porous substrate membrane when the thin film membrane is cast onto the porous substrate membrane by the method described below.

In one embodiment, the composite membrane of the present invention can be prepared by a wet process which comprises the steps of:

(i) providing a porous substrate membrane including a hydrophobic polymer;

(ii) casting a solution comprising chitosan complexed with an anionic surfactant on the porous substrate membrane to form a first intermediate; and

(iii) drying the first intermediate to form the composite membrane.

In one embodiment, the composite membrane of the present invention can be prepared by a wet process which comprises the steps of:

(i) providing a porous substrate membrane including a hydrophobic polymer;

(ii) casting a solution consisting essentially of chitosan complexed with an anionic surfactant on the porous substrate membrane to form a first intermediate; and

(iii) drying the first intermediate to form the composite membrane.

In one embodiment, the solution is an aqueous acid solution, such as aqueous acetic acid.

The solution of chitosan complexed with an anionic surfactant can be deposited or coated on the porous substrate membrane by way of a dip coating technique or by way of a casting knife.

Examples of polymers comprising the porous substrate membranes within the scope of this invention include polysulfone, polyetherimide, polyvinylidene fluoride, and polystyrene.

Examples of suitable anionic surfactants include sodium dodecyl sulfate, sodium laurate, sodium stearate, dioctyl sodium sulfosuccinate, and amphoteric sodium N-lauroyl sarcosinate. An exemplary anionic surfactant is dioctyl sodium sulfosuccinate, which is from the sulfosuccinate group.

In one embodiment, the anionic surfactant is a non-linear, branched chain anionic surfactant. In this context, a non-linear, branched chain surfactant is a molecule including two ends, a first and a second end, wherein a polar portion is located at one end of the molecule, and wherein a non-polar portion forms the other end of the molecule and comprises a hydrocarbon chain including a branch of another linear chain. In anionic surfactants, the polar portion is characterized by a negative charge on active groups. The polar portion often includes sulfate, sulfonate, or carboxylate groups. In some instances, the polar portion may include a polyethoxylate, or succinate group. This polar portion may also have more than one polar group such as sulfonate and carboxylate groups that are in close proximity i.e separated by one or two carbon atoms in the linear chain.

The branched chain of the non-linear, branched chain surfactant may consist of two or more bond lengths comprising of either carbon attached to carbon atom, carbon attached to an oxygen atom, carbon attached to a sulphur atom, or carbon attached to a nitrogen atom. In other words, chains including ether, amide, phenolic or aromatic groups are not excluded. An example of such a non-linear, branch chained surfactant is illustrated below:

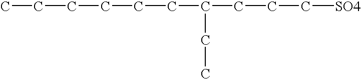

The non-linear, branched chain surfactant further includes a molecule where the polar portion is not located at the end of the molecule but is located intermediate the two ends of the molecule, wherein first and second nonpolar portions extend from the polar portion to forms the two ends of the molecule. Each of the nonpolar portions consists of a hydrocarbon chain, and the hydrocarbon chain on at least one of the non-polar portions includes a branch of another linear chain. The branched chain may consist of two or more bond lengths comprising either carbon attached to carbon atom, carbon attached to oxygen atom, carbon attached to sulfur atom, or carbon attached to nitrogen atom. In other words, chains including ether, amide, phenolic or aromatic groups are not excluded. An example of such a non-linear, branch chained surfactant is dioctyl sodium sulfosuccinate, and is illustrated in FIG. 3 as surfactant (E).

By way of contrast, linear anionic surfactants include a polar portion confined to one end of the chain, while the non-polar portion extends from the polar portion to form the other end of the molecule. Examples of such linear anionic surfactants include sodium dodecyl sulfate, sodium laurate, sodium stearate, and amphoteric sodium N-lauroyl sarcosinate, and are illustrated in FIG. 3 as surfactants (A), (B), (C), and (D), respectively.

By way of example, the following describes a method of preparing a composite membrane of the present invention, where the composite membrane comprises: (i) a thin film membrane including chitosan bonded to an anionic surfactant, and (ii) a porous substrate, the porous substrate including a first layer comprising a porous substrate membrane, wherein the porous substrate membrane includes a hydrophobic polymer or a polymer characterized by no more than 0.3% water absorption according to ASTM-D570, and a second layer comprising a non-woven fabric. In this case, the polymer of the porous substrate membrane is polyetherimide. A polyetherimide casting solution is cast upon a non-woven fabric, such as a polyester non-woven fabric, to form an intermediate porous substrate. A solution of chitosan complexed with an anionic surfactant is then cast on the intermediate porous substrate to form an intermediate composite membrane. The intermediate composite membrane is then dried to form the composite membrane of the present invention.

The composite membrane of the present invention is useful in the pervaporation separation of liquid mixtures comprising polar and non-polar components, such as a liquid alcohol mixed with one or more non-polar organic liquids.

The present invention will be further described with reference to the following non-limitative example. A schematic diagram of a pervaporation apparatus 10 used in the illustrative example described below is shown in FIG. 1. The feed solution temperature in the tank 12 was controlled to the desired value, and the feed solution 14 is circulated using the feed pump 16. The membrane was placed on the porous stainless steel support 18 of the membrane cell 20 and sealed. The effective area of the membrane in contact with the feed stream was 14.2 cm². Pervaporation was initiated by switching on the circulation pump 16 and vacuum pump 22, the pressure at permeate side was maintained around 3 mbar. Permeate was collected in the cold trap 24 which were immersed in liquid nitrogen. The pervaporation apparatus 10 was run for at least 2 hours to reach the equilibrium state before starting to measure permeate. When sufficient permeate was collected in the cold trap 24, the vacuum valve 28 was switched to the parallel trap 26 to collect a further sample. The cold trap 24 containing the permeate was warmed up to ambient temperature, then removed, and weighed to determine the flux and the contents were analyzed for permeate composition.

### EXAMPLE 1

Composite membranes comprising a film case from a chitosan/surfactant complex solution supported by the porous PEI membrane were prepared using a wet process.

Porous polyetherimide (PEI) membranes were prepared via the wet phase inversion technique from casting solutions containing 18 wt. % PEI (in the form of aromatic polyetherimide, 77 wt. % N-dimethylacetamide (DMAc), and 5% ethylene glycol. The casting solution was cast onto a polyester non-woven fabric held on a glass plate with the aid of a casting knife. The cast film was immediately immersed into a coagulation bath. The resulting membrane was washed thoroughly in de-ionized water, and then air-dried completely at ambient temperature. Initial microporous PEI membranes showed a pure water permeation rate of 115.8 kg/m²h at transmembrane pressure of 100 psi and operating temperature 22° C. Most of the water flux tests were performed in replicate to achieve accuracy.

Next, surfactant modified chitosan films were cast on the PEI membranes. Initially, a chitosan solution of 0.8 wt % chitosan (in the form of chitosan flakes (Flonac-N) with molecular weight=100,000 and 99% N-deacetylation degree) was prepared. A surfactant, dissolved in water, was added into the prepared chitosan solution and blended for several hours to obtain homogeneous chitosan/surfactant complex solution. The different anionic surfactants used were sodium dodecyl sulfate (SDS), sodium laurate (SL), sodium stearate (SS), dioctyl sodium sulfosuccinate (DSSS), and amphoteric sodium N-lauroyl sarcosinate (SLS). The chitosan/surfactant solutions were filtered to remove any dissolved solids and impurities. The chitosan/surfactant solutions were then cast onto the porous PEI membranes and dried for 24 hours at ambient temperature. In order to assess the effect of surfactant addition for the chitosan top layer thickness, the same amounts of chitosan solutions were cast on the porous substrates. The composite membranes were used for the pervaporation separation experiment without any further post treatment.

The composite membranes were used to facilitate pervaporation separation of methanol from a mixture of methanol and methyl-t-butylether (MTBE).

Membrane performance was characterized by permeation flux (“J”) and separation factor (“∞”), which were defined as follows:

$$J = \frac{Q}{At}$$

where “Q” is the amount of the permeate (kg), “A” the membrane area (m²) and “t” the operating time (hours).

$$∝ = \frac{Y / ( 1 - Y )}{X / ( 1 - X )}$$

where X and Y are the weight fractions of the more permeable component, methanol, in the feed and permeate respectively.

The permeate composition was analyzed using an HP 5890 gas chromatograph (GC) with a TCD detector. The column used in GC analysis was 6 ft×0.125 ft packed with Porapak Q.

The rheological data were collected using a Fann coaxial cylinder viscometer at room temperature. This instrument consisted of a stationary inner cylinder surrounded by a rotating outer (concentric) cylinder. The outer cylinder rotated at a known speed the torque (dial reading) on the inner cylinder was measured. The internal radius of the rotor of this viscometer was 1.8415 cm. The bob had a radius of 1.7245 cm. In order to make sure that wall effects were absent, the rheological data of chitosan/surfactant solutions were collected with a larger gap-width bob-rotor system as well. It was found that there were no wall effects present in these measurements.

Scanning electron microscopy (SEM) was used to study the cross-section morphology of the various composite membranes, and to measure the thickness of the membrane. Cryogenic fracturing of the membrane was done after freezing the samples in liquid nitrogen. All specimens were coated with a conductive layer (400 Å) of sputtered gold. A Jeol JSM 805 SEM was used for the specimens at 20 k V.

Atomic force microscopy (AFM) of Digital Instruments, Santa Barbara, Calif., USA was used to study membrane surface morphology. The AFM images are taken in the contact mode based on the optical lever cantilever detection design. The images presented in this study contain 256×256 data points. The Si₃N₄ cantilevers used for imaging were between 1 μm in length and possessed a spring constant in the 0.1-0.6 N/m range. The force applied for imaging ranged from 1.0 to 100 nN.

The morphology of the composite membranes prepared in this study is shown in FIGS. 5(a) to (d). It is apparent that dense chitosan top layer is coated on the top of finger-like microporous PEI membrane. Top layer thickness of pure chitosan (CS) is about 10 μm in FIGS. 5(a) and (b). When the casting solution is complexed with anionic surfactant, the top layer thickness of the composite membrane was drastically decreased. The thickness of complexed chitosan layer was about 2 μm as shown in FIGS. 5(c) and (d) and is the direct result of chitosan/surfactant association behavior.

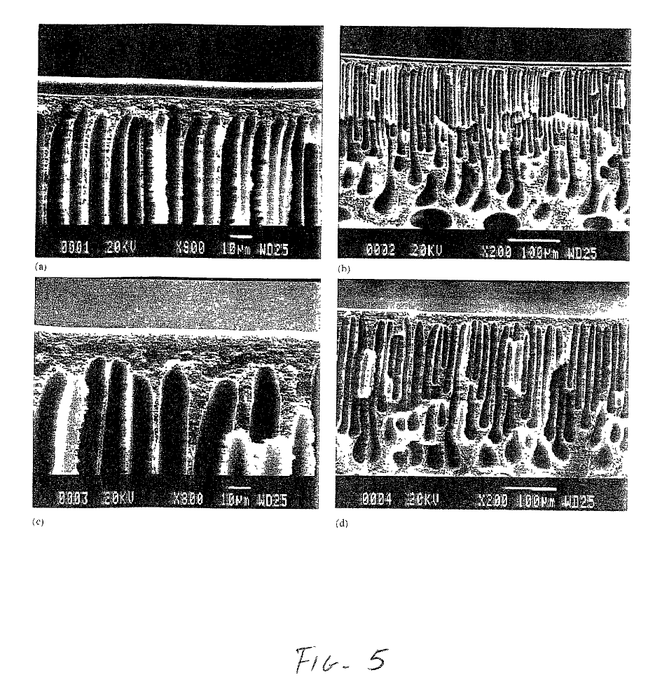

The solution viscosities of the composite membranes were measured using the cylinder viscometer and the results were plotted in FIG. 6. Upon the addition of oppositely charged surfactant (0.005 wt. % based on the total weight of chitosan solution) to the chitosan solution, the chitosan solution viscosities deceased drastically for all cases. Newtonian behavior was observed for all DSS, SDS and SS surfactants. Without wishing to be bound by theory, it is believed that this behavior is attributable to conformational changes to the chitosan chain. Referring to FIG. 2, and particularly the arrangement (A), the arrangement is not thermodynamically stable because the alkyl portion faces toward the solution. As a result, surfactants will attract other hydrophobic portions in the solution which can be offered by other hydrophobic tails of surfactants, leading to the conformational rearrangement of chitosan chain into a much reduced size occurs, as illustrated in the arrangement (C). It is believed that the size reduction results in the reduction of viscosity.

Further evidence of the size reduction in the chitosan molecule upon surfactant addition is the SEM pictures of FIGS. 5(a) and (c), representing the top layer thickness of pure chitosan and surfactant modified chitosan, respectively. As described above, upon surfactant addition to the casting solution, the thickness of the chitosan film cast from the casting solution was significantly reduced relative to the chitosan film cast from the casting solution without surfactants. These observations are believed to be attributable to the size reduction of polymer chains, thereby decreasing the degree of overlapping significantly, and providing a mutually shared framework.

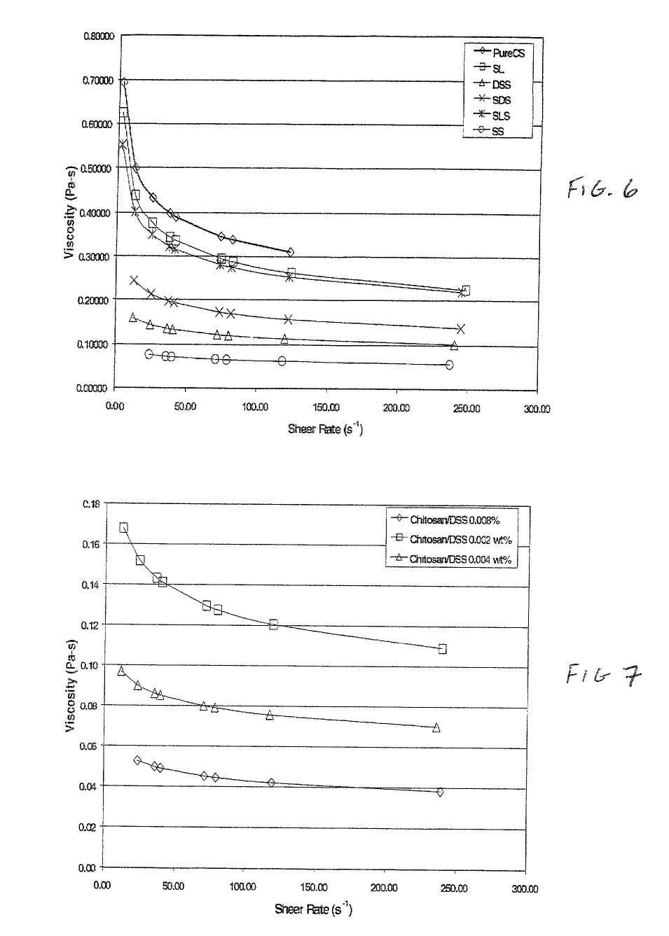

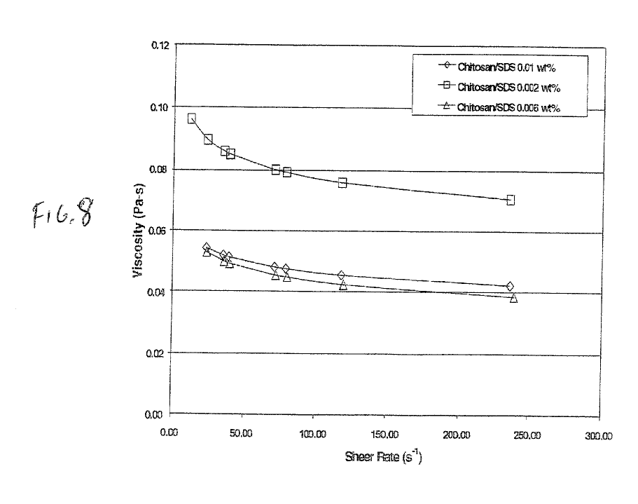

The effect of surfactant concentration on the solution viscosity is shown in FIGS. 7 and 8. Concentrations of DSS and SDS surfactants were increased from 0.002 to 0.008% and 0.002 to 0.01%, respectively. Solution viscosities generally decrease with increasing concentration of surfactants. During the preparation of the solutions, the turbidity of the solutions, that is, the typical phenomenon of critical micelle concentration, was not observed over the explored concentration range. However, in the case of SDS, solution viscosity with added 0.01% SDS is not lower than that of added 0.006% SDS. It was found that the precipitates occurred at 0.01% SDS, which might suggest that 0.01% was already over the critical micelle concentration.

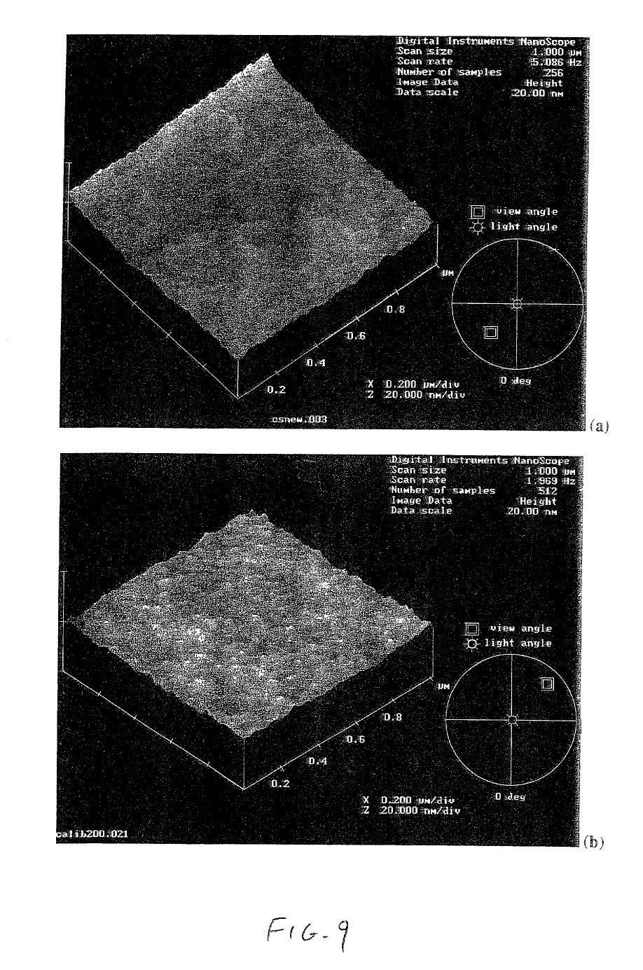

Possible changes to membrane surface morphology due to the addition of surfactant was studied by means of AFM. Two composite membranes were prepared with the solutions of pure CS and 0.006% SDS added chitosan. FIG. 9 presents the AFM images of membranes without surfactant (a) and with SDS addition (b). From the images, it is clear that the roughness of membrane modified with surfactant is larger than that of non-surfactant membrane. As explained above, upon the addition of surfactant, the chitosan chain experienced chain shrinkage or chain reduction arising from the attraction among surfactant tails, contributing to membrane roughness. Roughness of image (b) can be explained by the coagulation of polymer chains caused by surfactant molecules.

Pervaporation experiments were carried out with the composite membranes including films cast from the various chitosan/surfactant complex solutions with 0.005 wt % surfactants based on the total weight of the solution (each membrane including a film cast from a chitosan/surfactant complex solution including a different anionic surfactant (SDS, SL, SS, DSS, and SLS). FIG. 10 confirms that methanol is the component separated selectively through the chitosan composite membranes because of the high methanol content in the permeate. This implies that the existence of surfactant does not substantially alter the separation characteristics of chitosan complex membranes. The fluxes of SL and SS complexed membranes are less than that of pure CS. The SL and SS complexed membranes have carboxyl (RCOO⁻) head groups and linear alkyl groups. DSS complexed membranes appear to be characterized by high flux and reasonable separation efficiency. This can be attributed, at least in part, to its unique chemical structure as depicted in FIG. 2 (surfactant (E)). Not wishing to be bound by theory, it is believed that the nonlinear morphology of the DSS molecule creates a more loose, or a less packed matrix by hindering the close packing and intermolecular binding of chitosan polymer chain. This increased space appears to accommodate permeant, resulting in the high permeation flux.

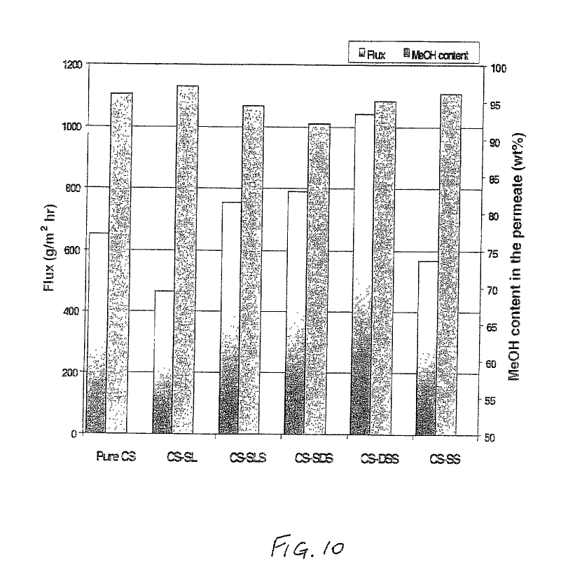

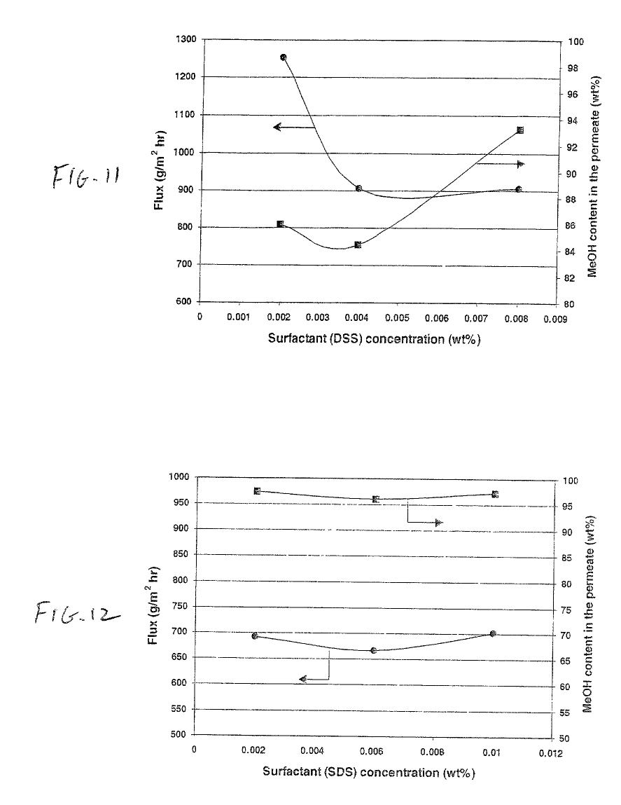

The effect of surfactant concentration in the chitosan/surfactant complex solution cast on a PEI support membrane was also studied. Three different surfactant concentrations for DSS and SDS surfactants were studied in terms of the flux and separation efficiency (on the basis of methanol content in the permeate). Referring to FIG. 11, it was observed that flux was drastically decreasing with the increase of DSS surfactant from 0.002 to 0.004%. There are two possible explanations for this phenomenon. First, more surfactant molecules are bound onto the chitosan polymer chain upon the increase of surfactant amount and surfactants block the possible passage between the chains. That is, the membrane matrix is more entangled. Second, surfactants binding the polymer chain will mitigate the gyroscopic movement of polymer chains by offering geometrical hindrance, which results in the lessened permeation flux. However, with the further increase of surfactant from 0.004 to 0.008%, there is no significant variation for the permeation flux. It is believed that 0.008% is already over or around the critical micelle concentration which does not change the conformation of the polymer chains. It was found that complete dissolution of 0.008% DSS into chitosan solution was extremely difficult and so was that of 0.01% SDS as shown in FIG. 12. A slight increase of the flux is shown at 0.01% SDS in FIG. 12. It is postulated that the cores of micelles substantially formed over 0.006% SDS offer the passages for methanol. This postulate can also explain the increase of separation efficiency (methanol content in the permeate) from 0.006 to 0.01% SDS as shown in FIG. 12 and from 0.004 to 0.008% DSS in FIG. 11.

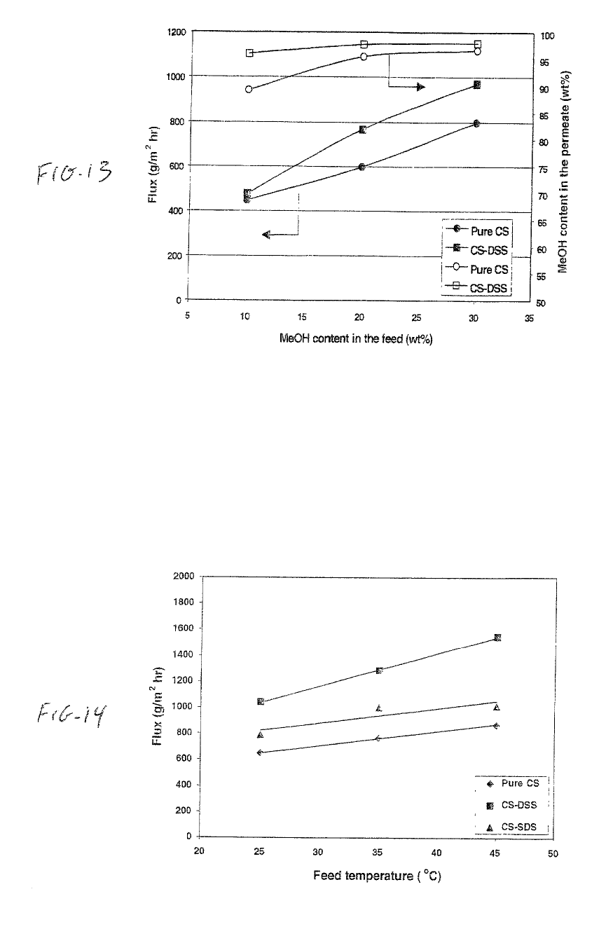

The feed concentration effect was investigated for a composite membrane comprising a pure chitosan film cast on a PEI support membrane, and a composite membrane comprising a chitosan/DSS complex film cast on a PEI support at 25° C. operating temperature and is presented in FIG. 13. The flux for the composite membrane with the chitosan/DSS complex film is larger than that of the composite membrane with the pure chitosan film. Flux difference increased according to the increase of methanol content in the feed mixture from 10 to 30%. The larger flux of the composite membrane with the chitosan/DSS complex film is believed to be attributable, at least in part, to the relatively thin chitosan/DSS complexed film and its relatively good mass transport properties.

In FIG. 13, the methanol content in the permeate for the composite membrane with the chitosan/DSS complex film is still larger than that of the composite membrane with the pure chitosan film, without the common trade-off phenomenon occurring between the flux and separation efficiency. Without wishing to be bound by theory, it is believed that these observations can be attributed to the enhanced affinity to methanol after the incorporation of surfactant molecules on the chitosan chain. It is postulated that surfactant molecules control the hydrophilic-hydrophobic balance of the composite membrane which is of importance for organic-organic separation membranes.

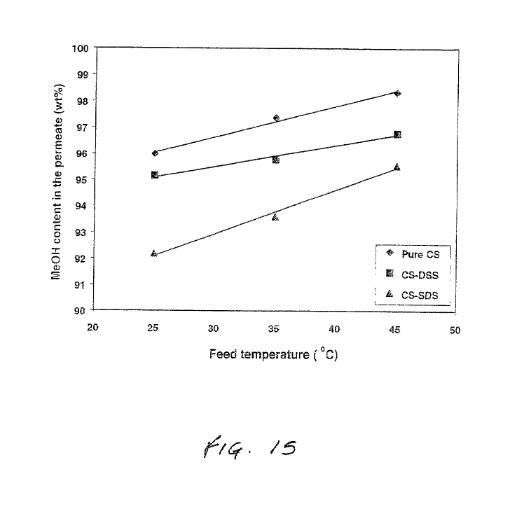

FIGS. 14 and 15 show the temperature effect on the flux and separation efficiency, respectively, for various composite membranes for pervaporation separation of 20%. FIGS. 14 and 15 illustrate that flux increases with temperature for this case.

Although the disclosure describes and illustrates preferred embodiments of the invention, it is to be understood that the invention is not limited to these particular embodiments. Many variations and modifications will now occur to those skilled in the art. For definition of the invention, reference is to be made to the appended claims.

1. A composite membrane material comprising:
an active membrane including chitosan complexed with an anionic surfactant; and
a porous substrate membrane including a hydrophobic polymer.

2. The composite membrane as claimed in claim 1, wherein the active membrane is physically adhered to the porous substrate membrane.

3. The composite membrane as claimed in claim 2, wherein the active membrane and the porous substrate define an interface, and wherein the porous substrate membrane includes an interfacial surface disposed at the interface, wherein the hydrophobic polymer of the porous substrate membrane is disposed at the interfacial surface.

4. The composite membrane as claimed in claim 3, wherein the chitosan is bonded to the anionic surfactant.

5. The composite membrane as claimed in claim 4, wherein the hydrophobic polymer of the porous substrate membrane is characterized by no more than 0.3% water absorption according to ASTM-D570.

6. The composite membrane as claimed in claim 5, wherein the anionic surfactant is a non-linear, branched chain surfactant.

7. The composite membrane as claimed in claim 5, wherein the hydrophobic polymer includes any of polysulfone, polyetherimide, polyvinylidene fluoride, or polystyrene.

8. The composite membrane as claimed in claims 5, wherein the active membrane includes at least 50 wy % chitosan based on the total weight of the active membrane.

9. A composite membrane material comprising:
an active membrane consisting essentially of chitosan complexed with an anionic surfactant; and
a porous substrate membrane including a hydrophobic polymer.

10. The composite membrane as claimed in claim 9, wherein the active membrane is physically adhered to the porous substrate membrane.

11. The composite membrane as claimed in claim 10, wherein the active membrane and the porous substrate define an interface, and wherein the porous substrate membrane includes an interfacial surface disposed at the interface, wherein the hydrophobic polymer of the porous substrate membrane is disposed at the interfacial surface.

12. The composite membrane as claimed in claim 11, wherein the chitosan is bonded to the anionic surfactant.

13. The composite membrane as claimed in claim 12, wherein the hydrophobic polymer of the porous substrate membrane is characterized by no more than 0.3% water absorption according to ASTM-D570.

14. The composite membrane as claimed in claim 13, wherein the anionic surfactant is a non-linear, branched chain surfactant.

15. The composite membrane as claimed in claim 13, wherein the hydrophobic polymer includes any of polysulfone, polyetherimide, polyvinylidene fluoride, or polystyrene.

16. The composite membrane as claimed in claims 13, wherein the active membrane includes at least 50 wt % chitosan based on the total weight of the active membrane.

17. A composite membrane material comprising:
an active membrane including chitosan complexed with a non-linear branched chain anionic surfactant; and
a porous substrate membrane.

18. The composite membrane material as claimed in claim 17, wherein the non-liner branched chain surfactant is a sulfosuccinate salt.

19. The composite membrane as claimed in claim 18, wherein the sulfosuccinate salt is dioctyl sodium sulfosuccinate.

20. The composite membrane as claimed in claim 17, wherein the active membrane is physically adhered to the porous substrate membrane.

21. A composite membrane material comprising:
an active membrane consisting essentially of chitosan complexed with a non-linear branched chain anionic surfactant; and
a porous substrate membrane.

22. The composite membrane material as claimed in claim 21, wherein the non-linear branched chain surfactant is a sulfosuccinate salt.

23. The composite membrane as claimed in claim 22, wherein the sulfosuccinate salt is dioctyl sodium sulfosuccinate.

24. The composite membrane as claimed in claim 21, wherein the active membrane is physically adhered to the porous substrate membrane.

25. A composite membrane formed by a method comprising the steps of:
(i) providing a porous substrate membrane including a hydrophobic polymer;
(ii) casting a solution comprising chitosan complexed with an anionic surfactant on a surface of the porous substrate membrane to form a first intermediate; and
(iii) drying the first intermediate to form the composite membrane.

26. The composite membrane as claimed in claim 25 wherein the hydrophobic polymer is disposed on the surface of the porous substrate membrane.

27. The composite membrane as claimed in claim 26, wherein the solution is an aqueous acid solution.

28. The composite membrane as claimed in claim 27, wherein the chitosan is bonded to the anionic surfactant.

29. The composite membrane as claimed in claim 28, wherein the polymer of the porous substrate membrane is characterized by no more than 0.3% water absorption according to ASTM-D570.

30. The composite membrane as claimed in claim 29, wherein the hydrophobic polymer includes any of polysulfone, polyetherimide, polyvinylidene fluoride, or polystyrene.

31. The composite membrane as claimed in claim 30, wherein the anionic surfactant is a non-linear branch chained surfactant.
